(19) United States
(12) Patent Application Publication
(10) Pub. No.: US 2026/0226979 A1
(43) Pub. Date: Aug. 6, 2026

(54) TRANSMISSION HAVING AN ADDITIVELY MANUFACTURED VALVE BODY

(71) Applicant: Ford Global Technologies, LLC, Dearborn, MI (US)

(72) Inventor: Steven Anatole Frait, Milan, MI (US)

(73) Assignee: Ford Global Technologies, LLC, Dearborn, MI (US)

(21) Appl. No.: 19/043,955

(22) Filed: Feb. 3, 2025

(51) Int. Cl. F16H 61/00; B33Y 80/00

(52) U.S. Cl. CPC F16H 61/0009; B33Y 80/00; F16H 2061/0043

(57) ABSTRACT

A transmission includes a case and a unitized valve body. The case includes a plurality of fluid conduits. The unitized valve body includes a plurality of valve bores and a plurality of hydraulic openings. Each valve bore is configured to receive a valve. The plurality of hydraulic openings are in fluid communication with the valve bores and in fluid communication with the plurality of fluid conduits. The plurality of hydraulic openings open through one side of the unitized valve body and are positioned between the plurality of fluid conduits and the plurality of valve bores.

### FIELD

The present disclosure relates to a transmission having an additively manufactured valve body.

### BACKGROUND

The statements in this section merely provide background information related to the present disclosure and may not constitute prior art.

Transmission valve bodies typically consist of aluminum castings with worm trail routing of multiple connections between various working elements. These worm trail fluid paths typically must be two-dimensional, and cannot cross over a path of another trail. Due to this two-dimensional limitation of typical transmission valve bodies, providing a flow path from one element to another can often require a lengthy and convoluted path that adds to the complexity, and size of the casting.

One method of overcoming this two-dimensional limitation includes manufacturing multiple valve bodies, each having its own two-dimensional worm trails, and connecting the valve bodies with one or more separator plates configured to permit fluid communication between the worm trails of the valve bodies in a third dimension at predetermined locations. Such separator plates require gasket seals and precise machining of the gasket surfaces. These separator plates also only allow binary cross-over of the hydraulic circuitry from one two-dimensional worm trail casting to another two-dimensional worm trail casting. Furthermore, the use of separator plates typically requires the use of additional fasteners to connect the assembly together. Additionally, the two-dimensional worm trails of each valve body must be routed around these fasteners, adding further size and complexity.

These sizing and complexity issues related to transmission valve bodies, among other issues related transmission valve bodies, are addressed by the present disclosure.

### SUMMARY

This section provides a general summary of the disclosure and is not a comprehensive disclosure of its full scope or all of its features.

In one form, the present disclosure includes a transmission that includes a case and a unitized valve body. The case includes a plurality of fluid conduits. The unitized valve body includes a plurality of valve bores and a plurality of hydraulic openings. Each valve bore of the plurality of valve bores is configured to receive a valve. The plurality of hydraulic openings are in fluid communication with the valve bores and in fluid communication with the plurality of fluid conduits. The plurality of hydraulic openings are open through one side of the unitized valve body and positioned between the plurality of fluid conduits and the plurality of valve bores.

In variations of the transmission of the above paragraph, which can be implemented individually or in any combination: a gasket is disposed between the plurality of fluid conduits and the plurality of hydraulic openings, the gasket defining openings that are in fluid communication with the plurality of fluid conduits and the plurality of hydraulic openings; the gasket includes filters disposed within the openings; the plurality of hydraulic openings are positioned between the plurality of fluid conduits and the plurality of hydraulic passages; a heat exchanger is disposed within the casing adjacent to the unitized valve body; all of the hydraulic openings of the unitized valve body open through the one side of the unitized valve body; the unitized valve body does not include mechanical fasteners; the unitized valve body is formed by additive manufacturing; the unitized valve body further includes a plurality of hydraulic passages in fluid communication with the valve bores and in fluid communication with the plurality of hydraulic openings; and the plurality of valve bores extend normal to the hydraulic passages and are arranged above and below the hydraulic passages.

In another form, the present disclosure includes a transmission that includes a case, an additively manufactured valve body, and a gasket. The case includes a plurality of fluid conduits. The valve body includes a plurality of valve bores and a plurality of hydraulic openings. Each valve bore of the plurality of valve bores is configured to receive a valve. The plurality of hydraulic openings are in fluid communication with the valve bores and are in fluid communication with the plurality of fluid conduits. The plurality of hydraulic openings are positioned between the plurality of fluid conduits and the plurality of valve bores. The gasket is disposed between the plurality of fluid conduits and the plurality of hydraulic openings. The gasket defines openings that are in fluid communication with the plurality of fluid conduits and the plurality of hydraulic openings.

In variations of the transmission of the above paragraph, which can be implemented individually or in any combination: the gasket includes filters disposed within the openings; the plurality of hydraulic openings are positioned between the plurality of fluid conduits and the plurality of hydraulic passages; the transmission further includes a heat exchanger disposed within the casing adjacent to the valve body; all of the hydraulic openings of the valve body open through one side of the valve body; the valve body does not include mechanical fasteners; the hydraulic openings of the valve body open through one side of the valve body; the valve body further includes a plurality of hydraulic passages in fluid communication with the valve bores and in fluid communication with the plurality of hydraulic openings; and the plurality of valve bores extend normal to the hydraulic passages and are arranged above and below the hydraulic passages.

In yet another form, the present disclosure includes a transmission that includes a case, an additively manufactured valve body, a heat exchanger, and a gasket. The case includes a plurality of fluid conduits. The additively manufactured valve body includes a plurality of valve bores, a plurality of hydraulic passages and a plurality of hydraulic openings. Each valve bore of the plurality of valve bores configured to receive a valve. The plurality of hydraulic passages are in fluid communication with the valve bores and arranged parallel to each other. The plurality of hydraulic openings are in fluid communication with the valve bores and in fluid communication with the plurality of fluid conduits. The plurality of hydraulic openings are positioned between the plurality of fluid conduits and the plurality of valve bores. The heat exchanger is disposed within the casing adjacent to the valve body. The gasket is disposed between the plurality of fluid conduits and the plurality of hydraulic openings. The gasket defines openings that are in fluid communication with the plurality of fluid conduits and the plurality of hydraulic openings. The plurality of hydraulic openings are positioned between the plurality of fluid conduits and the plurality of hydraulic passages.

In variations of the transmission of the above paragraph, the plurality of valve bores extend normal to the hydraulic passages and are arranged above and below the hydraulic passages.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a transmission having a valve body assembly according to the principles of the present disclosure;

FIG. 2 is a bottom view of the transmission of FIG. 1 including a valve body assembly coupled to a casing;

FIG. 3 is a perspective view of the transmission of FIG. 1 including the valve body assembly exploded from the casing;

FIG. 4 is a perspective view of a valve body of the valve body assembly of FIG. 1;

FIG. 5 is another perspective view of the valve body of the valve body assembly of FIG. 1;

FIG. 6 is yet another perspective view of the valve body of the valve body assembly of FIG. 1;

FIG. 7 is a perspective view of the valve body of the valve body assembly of FIG. 1 showing passages of the valve body;

FIG. 8 is a cross-sectional perspective view of the valve body of the valve body assembly of FIG. 1; and

FIG. 9 is a schematic view of a portion of a hydraulic circuit of the transmission of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

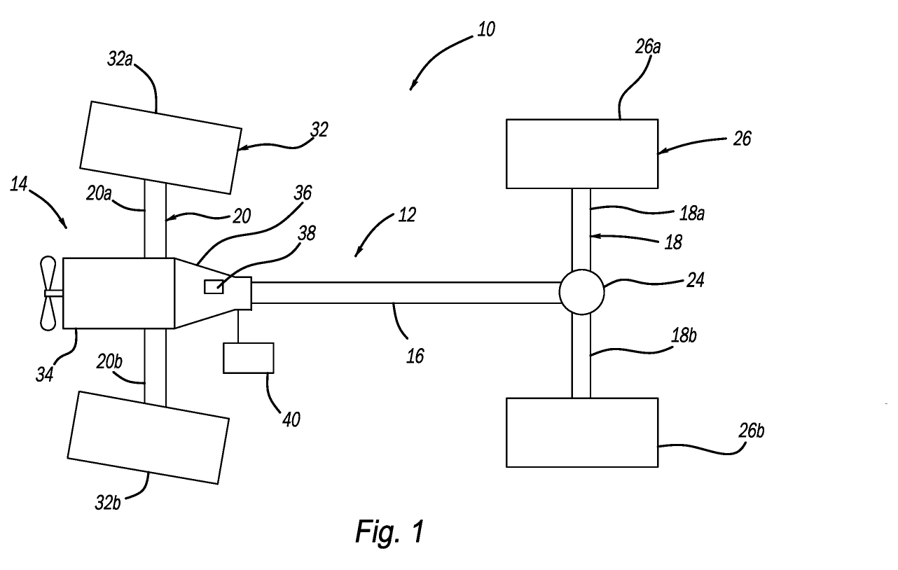

With reference to FIG. 1, a vehicle 10 is provided that includes a drivetrain system 12 and a powertrain system 14. In the particular configuration shown in FIG. 1, the drivetrain system 12 includes, inter alia, a propeller shaft 16, a primary axle 18, a secondary axle 20, and a rear differential 24. Rotary power (vehicle torque) generated by the powertrain system 14 is transmitted to the drivetrain system 12. That is, rotatory power generated by the powertrain system 14 is transmitted to the primary axle 18 via the propeller shaft 16 to drive a set of rear wheels 26. The primary axle 18 includes a first shaft 18a and a second shaft 18b. The first shaft 18a drives a first wheel 26a of the set of rear wheels 26 and the second shaft 18b drives a second wheel 26b of the set of rear wheels 26. The secondary axle 20 includes a first shaft 20a and a second shaft 20b. The first shaft 20a is connected to a first wheel 32a of a set of front wheels 32 and the second shaft 20b is connected to a second wheel 32b of the set of front wheels 32. The powertrain system 14 includes an engine 34 and a transmission 36 such as an automatic transmission, for example. The engine 34 generates rotary power and may be an internal combustion engine, for example.

The transmission 36 transmits rotary power from the engine 34 to the drivetrain system 12. The transmission 36 is generally controlled using hydraulic fluid. That is, the transmission 36 is cooled, lubricated, actuated, and modulates torque, for example, using hydraulic fluid. To these ends, the transmission 36 is in electrical communication with an electronic controller 40 used to direct, or control, flow of fluid throughout the transmission 36. In order to facilitate the flow of hydraulic fluid throughout the transmission 36, the vehicle 10 includes at least one or more pumps to supply pressurized fluid to the transmission 36. It should be appreciated that the pumps provide high flow high pressure hydraulic fluid to the transmission 36.

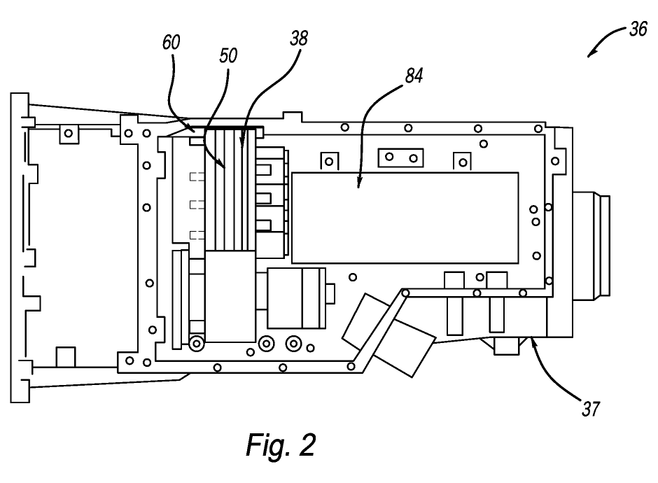

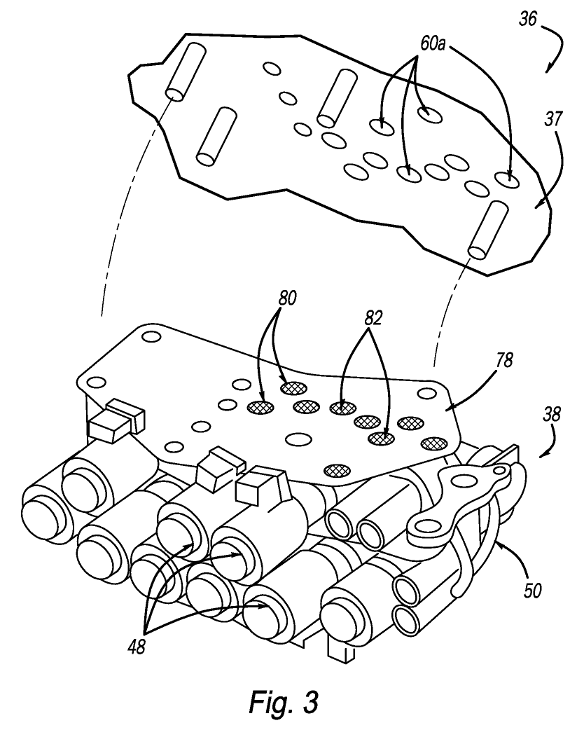

With reference to FIGS. 2 and 3, the transmission 36 includes, inter alia, a casing or case 37 and a valve body assembly 38. The casing 37 may house components of the transmission such as, for example, the valve body assembly 38, a clutch assembly (not shown), and fluid conduits or circuits 60 (only one shown in FIG. 2). The clutch assembly selectively couples first and second rotating elements (not shown) to one another. The fluid circuits 60 are in communication with the valve body assembly 38 and may permit hydraulic fluid to flow between the valve body assembly 38 and components disposed within the casing 37 (e.g., the clutch assembly). Portions of some fluid circuits 60 may be located external to the casing 37 and other portions of some fluid circuits 60 may be located inside of the casing 37. The fluid circuits 60 may include openings 60a (FIG. 3) that interface with the valve body assembly 38 and that are located within the casing 37 at a localized region of the casing 37. In the example illustrated, all the openings 60a of the fluid circuits 60 are located at a localized region of the casing 37. Stated differently, all of the openings 60a of the fluid circuits 60 are adjacent to each other at an area of the casing 37. In this way, the casing 37 does not include openings to fluid circuits located at different sides or regions of the casing 37, which reduces the fluid piping throughout the casing 37.

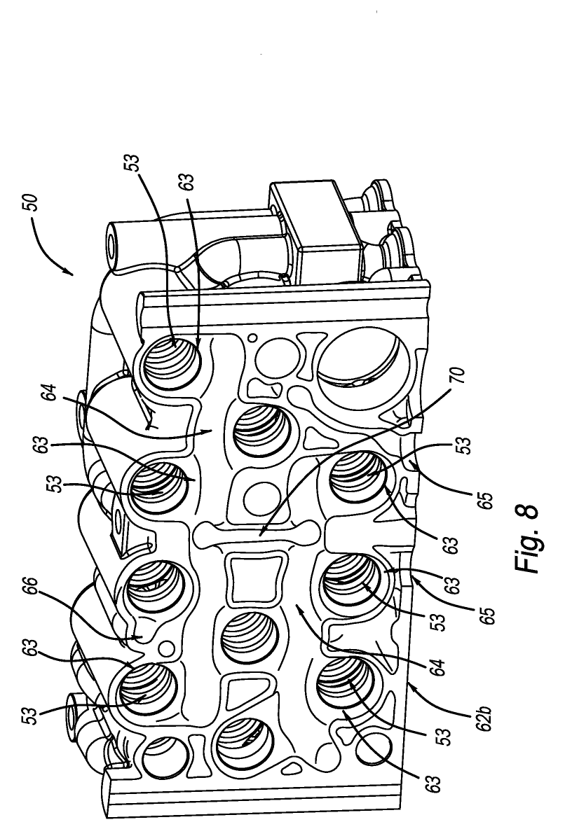

The valve body assembly 38 is secured to the casing 37 and includes a plurality of solenoid actuators 48 and a valve body 50. Each solenoid actuator 48 includes a spool valve (not shown; i.e., hydraulic control valve). The spool valve is slidably disposed within a corresponding valve bore 53 (FIG. 8) of the valve body 50 and is configured to be axially positioned by an armature (not shown) of the solenoid actuator 48 depending on an activation state of the solenoid actuator 48. The spool valve includes a plurality of cylindrical sealing segments (not shown) axially spaced apart from each other and having an outer diameter greater than adjacent lengths of the spool valve. A cylindrical surface (not shown) of the sealing segments is allowed to engage an inner cylindrical surface of the valve bore 53, while fluid communication is permitted in the areas between adjacent ones of the sealing segments. A spring (not shown) may bias the spool valve in an axial direction within the valve bore 53. The solenoid actuators 48 can be on/off actuators, variable pressure actuators, or variable flow actuators and can receive electrical power from an electrical source and can receive control signals from a control module.

The valve body 50 is in the form of a single unitized, monolithic body that can be manufactured by an additive manufacturing process. In this way, the valve body 50 does not include fasteners such as bolts, for example, securing two or more shells or housings to each other and/or to a plurality of separator plates. In one example, the manufacturing process can include aluminum binder jetting. In another example, the manufacturing process can include laser sintering, for example, that can generally include a laser, a means for applying subsequent layers of powdered sintering material (e.g., metal powder), and a controller that controls operation of the laser and the amount and timing of the deposition of the metal powder. It should be understood that other 3D printing/additive manufacturing methods may be employed to achieve the unitized, monolithic body, along with a variety of different materials, while remaining within the scope of the present disclosure.

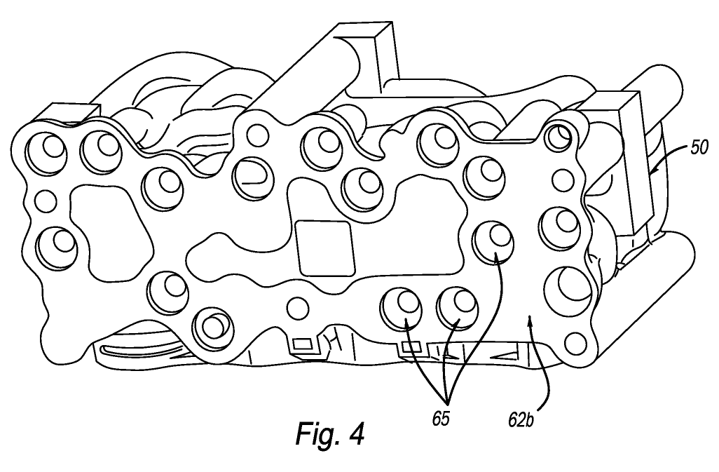

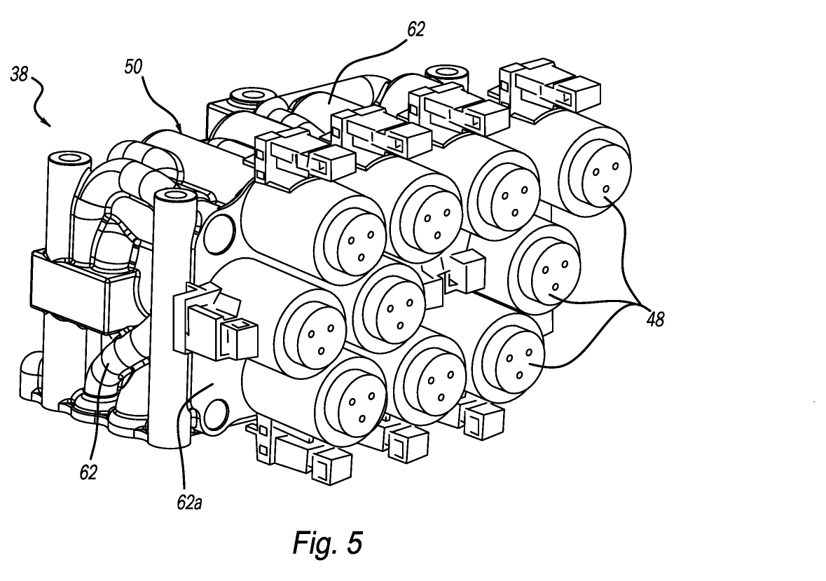

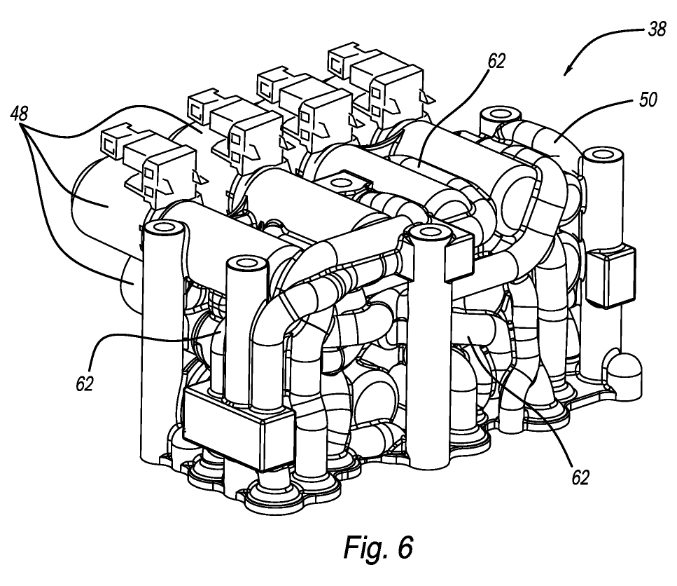

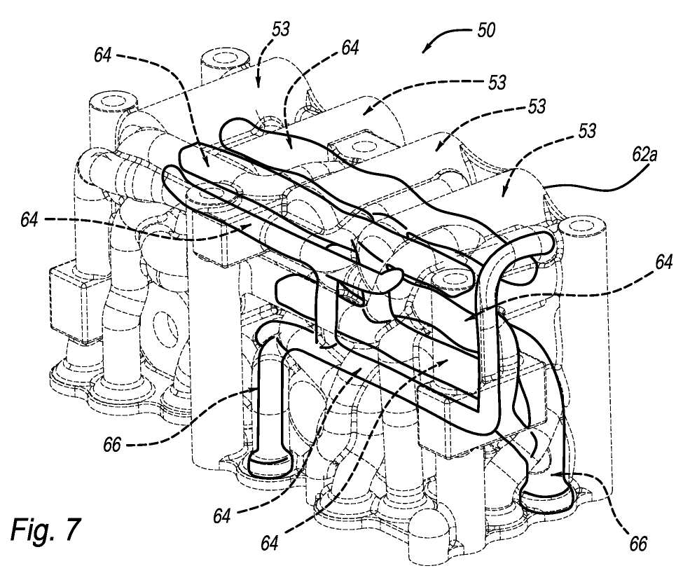

With reference to FIGS. 4-8, the valve body 50 includes a plurality of sides 62 and defines the plurality of valve bores 53 (FIGS. 7 and 8), a plurality of annuluses or rings 63 (FIG. 8) a plurality of trunk hydraulic passages 64 (FIGS. 7 and 8), and a plurality of hydraulic openings 65 (FIGS. 4 and 8). In the example illustrated, the valve bores 53 open through side 62a of the valve body 50. The plurality of annuluses 63 are axially spaced apart from each other along a corresponding valve bore 53. The annuluses 63 are also in fluid communication with the corresponding valve bore 53. Each annulus 63 is also in fluid communication with a corresponding passage 64 via an inlet/outlet port. One example of such annulus 63 is disclosed in Applicant’s co-pending application titled “UNITIZED VALVE BODY HAVING ANNULUS” which is commonly owned with the present application and the contents of which are incorporated herein by reference in its entirety.

With reference to FIG. 7, a plurality of connecting passages 66 are in fluid communication with different devices through the transmission 36. For example, the connecting passages 66 can be coupled to a corresponding one of a return line of a pump (not shown), an outlet of a cooling fluid circuit (not shown), a supply line of the pump (not shown), a clutch lubrication circuit (not shown), a clutch actuator (not shown) corresponding to the odd numbered gears (not shown) of the transmission 36, a filtered fluid inlet (not shown), or a clutch actuator (not shown) corresponding to the even numbered gears (not shown) of the transmission 36, though other devices can be used.

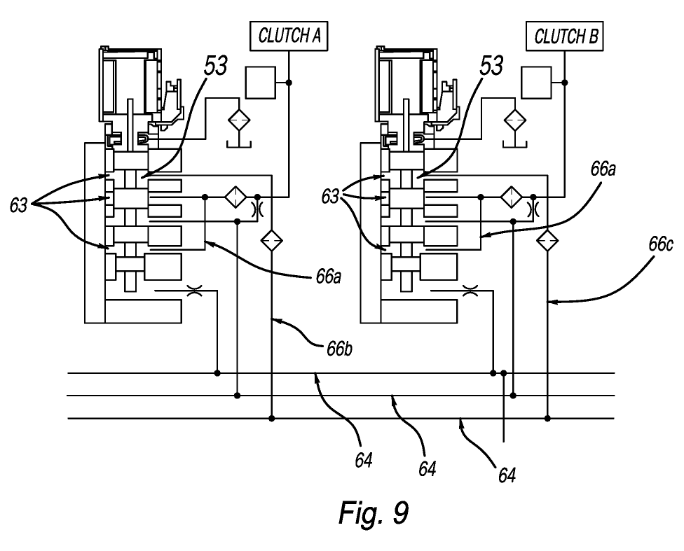

The plurality of connecting passages 66 are also in fluid communication with respective valve bores 53 and/or one or more hydraulic passages 64. As shown in FIG. 9, in one example, passage 66a fluidly connects one annulus 63 associated with a respective valve bore 53 to another annulus 63 associated with the respective valve bore 53. In another example, connecting passages 66b, 66c fluidly connect a respective annulus 63 associated with one valve bore 53 to a respective annulus 63 associated with another valve bore 53. The first and second connecting passages 66b, 66c may be fluidly connected via a respective hydraulic passage 64.

With reference to FIGS. 7 and 8, the hydraulic passages 64 may be connected to a pressurized fluid source such as a pump located external to the valve body 50. The hydraulic passages 64 are also in fluid communication with the valve bores 53 and are arranged parallel to each other. The valve bores 53 extend normal to the hydraulic passages 64 and are arranged above and below the hydraulic passages 64 in a staggered arrangement. In the example illustrated, each hydraulic passage 64 is substantially linear and has a generally circular cross-section. In some forms, the hydraulic passages 64 may have a semi-circular or other suitable cross-section, for example, allowing hydraulic fluid to easily flow through. One or more of the hydraulic passages 64 extend substantially a length of the valve body 50. A set of hydraulic passages 64 are arranged in a row and are fluidly isolated from each other. One hydraulic passage 64 of the set of hydraulic passages 64 arranged in one row is in fluid communication with a corresponding hydraulic passage 64 of another set of hydraulic passages 64 arranged in another row via a linking passage 70. The linking passage 70 extends normal to the hydraulic passages 64 and the valve bores 53.

With reference to FIGS. 4 and 8, the hydraulic openings 65 open through side 62b of the valve body 50 and are in communication with the hydraulic passages 64 and the fluid conduits 60 of the casing 37. In this way, hydraulic fluid may flow between the casing 37 and the valve body assembly 38 through the hydraulic openings 65. The hydraulic openings 65 interface with the fluid conduits 60 of the casing 37 at a location such that the hydraulic openings 65 are positioned between the fluid conduits 60 (and openings 60a) and the valve bores 53. In this way, lengths of the fluid circuits are reduced, which allows for a compact valve body and enhanced shifting of the transmission 36. In the example illustrated, the side 62b of the valve body 50 is perpendicular to the side 62a.

With reference to FIG. 3, a gasket 78 is disposed between the valve body 50 and the casing 37 and defines openings 80 that are in fluid communication with the fluid conduits 60 and the hydraulic openings 65. In the example illustrated, the gasket 78 includes filter media or filters 82 disposed within the openings 80 to further inhibit debris from entering into the fluid circuit of the transmission 36. The transmission 36 of the present disclosure further includes a heat exchanger 84 disposed at least partially within the casing 37. In one example, the heat exchanger 84 may be a cooler, for example, configured to cool fluid (e.g., transmission oil) of the transmission 36. That is, the additively manufactured valve body 50 permits the heat exchanger 84 to be disposed within the casing 37 adjacent to the valve body 50, thus, reducing conduit extending from the casing 37 to a heat exchanger located at a remote location relative to the transmission 36.

The present disclosure provides the benefit of having an additively manufactured valve body 50 including the hydraulic openings 65 located at a localized region and interfacing with the fluid conduits 60 at a location between the fluid conduits 60 and the valve bores 53. In this way, lengths of the fluid circuits are reduced, which allows for a compact valve body and enhanced shifting of the transmission 36. In some forms, the valve

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A transmission comprising:
a case including a plurality of fluid conduits; and
a unitized valve body including a plurality of valve bores and a plurality of hydraulic openings, each valve bore of the plurality of valve bores configured to receive
a valve, the plurality of hydraulic openings in fluid communication with the valve bores and in fluid communication with the plurality of fluid conduits, the plurality of hydraulic openings open through one side of the unitized valve body and positioned between the plurality of fluid conduits and the plurality of valve bores.

2. The transmission of claim 1, further comprising a gasket disposed between the plurality of fluid conduits and the plurality of hydraulic openings, the gasket
defining openings that are in fluid communication with the plurality of fluid conduits and the plurality of hydraulic openings.

3. The transmission of claim 2, wherein the gasket includes filters disposed within the openings.

4. The transmission of claim 1, further comprising a heat exchanger disposed within the case adjacent to the unitized valve body.

5. The transmission of claim 1, wherein all of the hydraulic openings of the unitized valve body open through the one side of the unitized valve body.

6. The transmission of claim 1, wherein the unitized valve body does not include mechanical fasteners.

7. The transmission of claim 1, wherein the unitized valve body is formed by additive manufacturing.

8. The transmission of claim 1, wherein the unitized valve body further includes a plurality of hydraulic passages in fluid communication with the valve bores and in fluid communication with the plurality of hydraulic openings.

9. The transmission of claim 8, wherein the plurality of valve bores extend normal to the hydraulic passages and are arranged above and below the hydraulic passages.

10. The transmission of claim 9 , wherein the plurality of hydraulic openings are positioned between the plurality of fluid conduits and the plurality of
hydraulic passages.

11. A transmission comprising:
a case including a plurality of fluid conduits;
an additively manufactured valve body including a plurality of valve bores and a plurality of hydraulic openings, each valve bore of the plurality of valve bores configured to receive a valve, the plurality of hydraulic openings in fluid communication with the valve
bores and in fluid communication with the plurality of fluid conduits, the plurality of hydraulic openings positioned between the plurality of fluid conduits and the plurality of valve bores; and
a gasket disposed between the plurality of fluid conduits and the plurality of hydraulic openings, the gasket defining openings that are in fluid communication with the plurality of fluid conduits and the plurality of hydraulic openings.

12. The transmission of claim 11, wherein the gasket includes filters disposed within the openings.

13. The transmission of claim 12, further comprising a heat exchanger disposed within the case adjacent to the valve body.

14. The transmission of claim 11, wherein all of the hydraulic openings of the valve body open through one side of the valve body.

15. The transmission of claim 11, wherein the valve body does not include mechanical fasteners.

16. The transmission of claim 11, wherein the hydraulic openings of the valve body open through one side of the valve body.

17. The transmission of claim 11, wherein the valve body further includes a plurality of hydraulic passages in fluid communication with the valve bores and in fluid communication with the plurality of hydraulic openings, and wherein the plurality of hydraulic openings are positioned between the plurality of fluid conduits and the plurality of hydraulic passages.

18. The transmission of claim 17, wherein the plurality of valve bores extend normal to the hydraulic passages and are arranged above and below the hydraulic passages.

19. A transmission comprising:
a case including a plurality of fluid conduits;
an additively manufactured valve body including a plurality of valve bores, a plurality of hydraulic passages and a plurality of hydraulic openings, each valve bore of the plurality of valve bores configured to receive a valve, the plurality of hydraulic passages in fluid communication with the valve bores and arranged parallel to each other, the plurality of hydraulic openings in fluid communication with the valve bores and in fluid communication with the plurality of fluid conduits, the plurality of hydraulic openings positioned between the plurality of fluid conduits and the plurality of valve bores;
a heat exchanger disposed within the case adjacent to the valve body; and
a gasket disposed between the plurality of fluid conduits and the plurality of hydraulic openings, the gasket defining openings that are in fluid communication with the plurality of fluid conduits and the plurality of hydraulic openings,
wherein the plurality of hydraulic openings are positioned between the plurality of fluid conduits and the plurality of hydraulic passages.

20. The transmission of claim 19, wherein the plurality of valve bores extend normal to the hydraulic passages and are arranged above and below the hydraulic passages.
